(19) United States
(12) Patent Application Publication
(10) Pub. No.: US 2013/0075565 A1
(43) Pub. Date: Mar. 28, 2013

(54) Screw clamp having attached anchoring board

(71) Applicant: Chih Feng Ho, Taipei (TW)

(72) Inventor: Chih Feng Ho, Taipei (TW)

(73) Assignee: Oxti Corporation

(21) Appl. No.: 13/200,262

(22) Filed: Sep. 22, 2011

(51) Int. Cl. F16B 2/12

(52) U.S. Cl. 248/316.4

(57) ABSTRACT

A screw clamp includes an anchoring board detachably attached to a carrier member with one or more latch devices at a working position where the anchoring board is perpendicular to the carrier member, a seat is slidably attached to the carrier member, and a screw is rotatably engaged with the seat and the carrier member for moving the carrier member and the anchoring board toward the seat. The carrier member includes two tracks, and the seat includes two engaging sockets for engaging with the tracks and for slidably anchoring the seat to the carrier member. The anchoring board includes one or more studs each having an engaging hole for engaging with latch members of the latch devices.

### BACKGROUND OF THE INVENTION

1. Field of the Invention

The present invention relates to a screw clamp or carrier or support device, and more particularly to a screw clamp or carrier or support device including an improved structure arranged for allowing the screw clamp or carrier or support device to be easily actuated or operated by the user, and including an anchoring board attachable to a carrier member for allowing the carrier member to be easily and quickly engaged through a tiny space beside an edge portion of a table plate.

2. Description of the Prior Art

Typical screw clamps comprise a C-shaped clamp body, and a bolt or screw threaded and attached or mounted to one end of the clamp body and rotatable and movable or adjustable toward the other end of the clamp body for attaching or mounting or securing or clamping the clamp body onto various supporting members or tables.

For example, U.S. Pat. No. 2,461,687 to Hopfeld, U.S. Pat. No. 3,269,766 to Gardner, U.S. Pat. No. 4,582,307 to Wang, U.S. Pat. No. 4,627,604 to Choi, U.S. Pat. No. 4,874,155 to Goul, U.S. Pat. No. 4,921,234 to Peterson, and U.S. Pat. No. 5,423,525 to Spainhower disclose several of the typical screw clamps each also comprising a bolt or screw threaded and attached or mounted to one end of the clamp body for clamping onto various supporting members or tables.

However, the clamp body may only be attached or mounted to the supporting members or tables, but may not be used to attach or support the other members or objects, such as the keyboards, the monitors or the like.

U.S. Pat. No. 6,394,403 to Hung, and U.S. Pat. No. 6,478,275 to Huang disclose the other typical screw clamps each also comprising a bolt or screw threaded and attached or mounted to the clamp body for clamping onto various supporting members or tables and for supporting the other members or objects, such as the keyboards, the monitors or the like.

However, the clamp body includes a solid and spatial structure that may not be folded to the compact folding structure and that may not be easily and quickly attached or mounted or secured or clamped onto various supporting members or tables. The users have to bend or squat lower than the supporting members or tables for actuating or operating or rotating or driving the screw or bolt to attach the clamp body onto the supporting members or tables.

The present invention has arisen to mitigate and/or obviate the afore-described disadvantages of the conventional screw clamps or carriers or support devices.

### SUMMARY OF THE INVENTION

The primary objective of the present invention is to provide a screw clamp including an improved structure arranged for allowing the screw clamp or carrier or support device to be easily actuated or operated by the user.

The other objective of the present invention is to provide a screw clamp including an anchoring board attachable to a carrier member for allowing the carrier member to be easily and quickly and readily engaged through a tiny space beside an edge portion of a table plate.

In accordance with one aspect of the invention, there is provided a screw clamp comprising a carrier member, an anchoring board attachable to the carrier member at a working position where the anchoring board is perpendicular to the carrier member, a seat slidably attached to the carrier member and movable relative to the carrier member, and a screw rotatably engaged with the seat and the carrier member for moving the carrier member and the anchoring board relative to the seat by rotating the screw relative to the seat and for allowing the anchoring board to be moved toward the seat with the screw.

The carrier member includes two tracks, and the seat includes two engaging sockets formed therein for engaging with the tracks of the carrier member and for slidably anchoring the seat to the carrier member.

A base plate may further be provided and secured to the seat and slidably attached to the carrier member, and includes a compartment formed therein for receiving or engaging with the tracks of the carrier member, and includes an orifice formed therein for receiving or engaging with the screw.

The anchoring board is detachably attached to the carrier member with at least one latch device. The anchoring board includes at least one stud extended therefrom, and the latch device is attached to the stud.

The stud of the anchoring board includes an engaging hole formed therein, the latch device includes a casing attached to the stud, and a latch member slidably engaged in the casing and slidably engaged in the engaging hole of the stud of the anchoring board and extendible out of the stud to selectively engage with the carrier member.

The casing includes a slot formed therein, and a knob is slidably engaged in the slot of the casing and secured to the latch member for moving the latch member along the casing and for moving the latch member to selectively engage with the carrier member. The carrier member includes an engaging groove formed therein for selectively engaging with the latch member and for detachably attaching or mounting the anchoring board to the carrier member.

The engaging groove of the carrier member includes a non-circular cross section, and the latch member includes a non-circular actuating end for selectively engaging with the non-circular engaging groove of the carrier member and for anchoring the anchoring board to the carrier member at the working position where the anchoring board is perpendicular to the carrier member.

The seat includes a through hole formed therein for receiving or engaging with the screw and includes a cavity formed therein and spaced from the through hole of the seat. The seat includes a cover having an aperture formed therein and aligned with the cavity of the seat.

The seat includes at least one anchoring depression formed therein, and the cover includes at least one catch extended therefrom for engaging with the anchoring depression of the seat and for anchoring the cover to the seat.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a screw clamp in accordance with the present invention;

FIG. 2 is a perspective view of the screw clamp;

FIG. 3 is a partial perspective view of the screw clamp;

FIG. 4 is a partial exploded view illustrating the operation of the screw clamp;

FIG. 5 is a side plan schematic view of the screw clamp, and

FIGS. 6, 7 are side plan schematic views similar to FIG. 5, illustrating the operation of the screw clamp.

### DETAILED DESCRIPTION OF THE PREFERRED EMBODIMENT

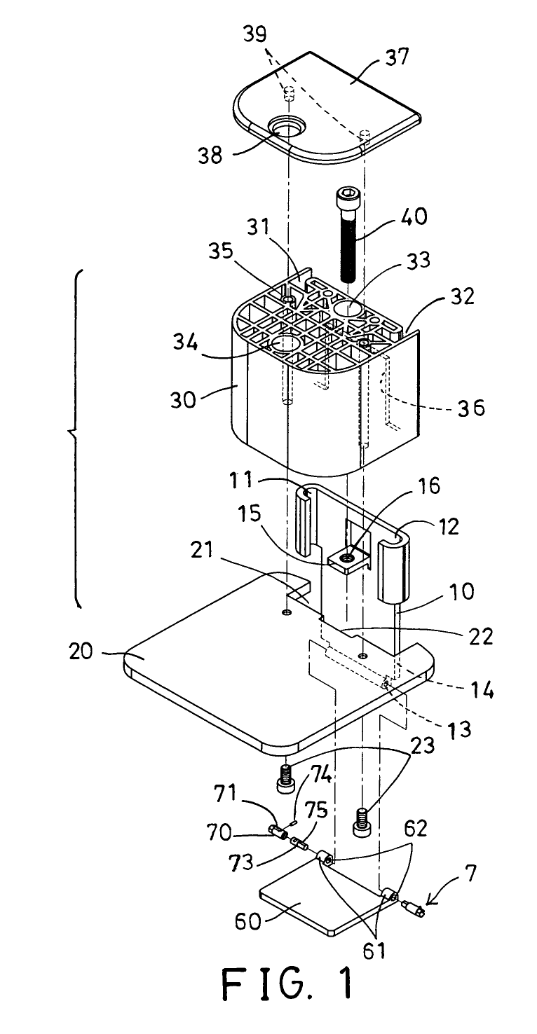

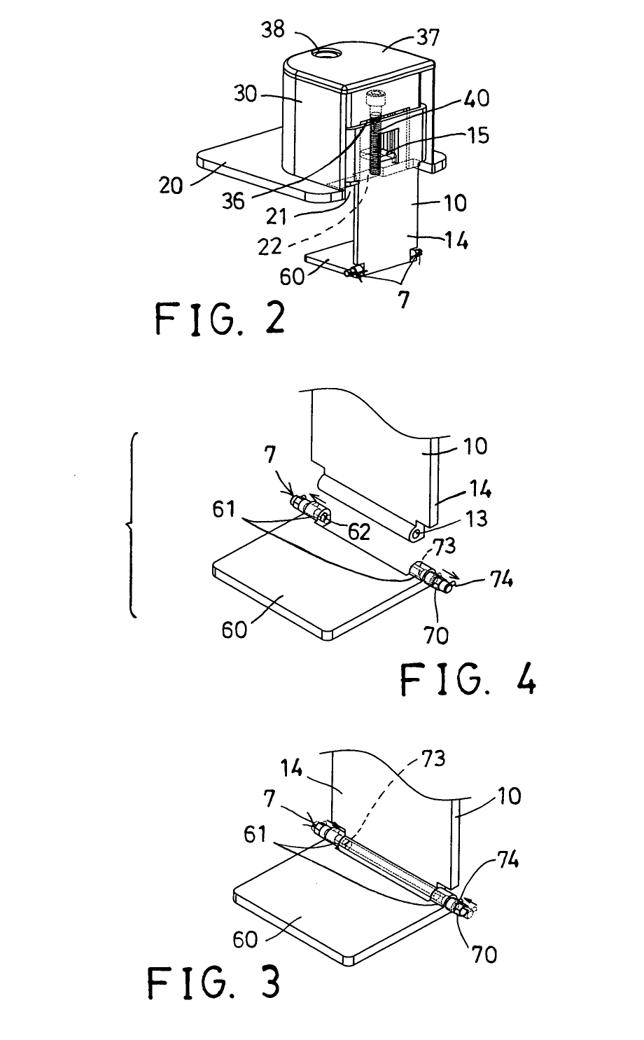

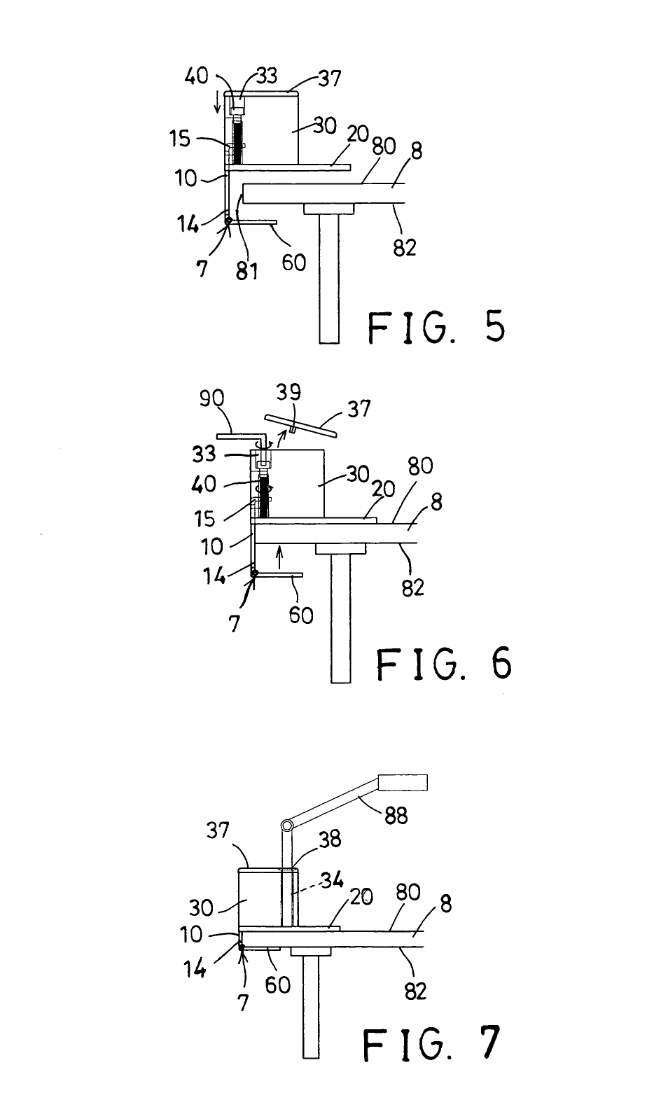

Referring to the drawings, and initially to FIGS. 1-2, a screw clamp in accordance with the present invention comprises a carrier or support plate or member 10 disposed or arranged perpendicular to a table top or table plate 8 (FIGS. 5-7) and to be attached or mounted or secured onto the table plate 8, and including one or more (such as two) side tracks 11, 12 oppositely formed therein, such as oppositely formed in the side portions thereof for forming a substantially C-shaped structure. A base plate 20 includes a compartment 21 formed therein for receiving or engaging with the tracks 11, 12 of the carrier member 10 and for attaching or mounting the base plate 20 to the carrier member 10, and includes an engaging notch 22 formed therein and communicative with the compartment 21 of the base plate 20, the base plate 20 is arranged to be engaged onto and supported on the upper surface 80 of the table plate 8.

A block or turret or seat 30 is disposed or engaged onto the base plate 20 and attached or mounted or secured onto the base plate 20 with one or more fasteners 23, the seat 30 includes one or more (such as two) engaging sockets 31, 32 formed therein for engaging with the tracks 11, 12 of the carrier member 10 and for guiding the seat 30 to slide up and down along and relative to the carrier member 10. The sliding engagement of the compartment 21 of the base plate 20 with the carrier member 10 may also be used to guide the base plate 20 and the seat 30 to slide up and down along and relative to the carrier member 10. The seat 30 includes a through hole 33 formed therein and disposed or located between the engaging sockets 31, 32 of the seat 30 for slidably receiving or engaging with a bolt or screw 40.

The seat 30 further includes a cavity 34 formed therein and spaced from the through hole 33 of the seat 30, and includes one or more (such as two) anchoring depressions 35 formed therein, and includes a space 36 formed therein, such as formed in the rear portion thereof. A cover 37 includes an aperture 38 formed therein and aligned with the cavity 34 of the seat 30, and includes one or more (such as two) keys or pegs or catches 39 extended outwardly therefrom for engaging with the anchoring depressions 35 of the seat 30 and for solidly and stably attaching or mounting or securing or anchoring the cover 37 to the seat 30. The aperture 38 of the cover 37 and the cavity 34 of the seat 30 may be used for plugging or inserting or engaging with various members or objects 88 (FIG. 7), such as the keyboards, the monitors 88, the lamps, the antenna members or the like.

An anchoring board 60 is to be attached or mounted or secured to the lower or bottom portion 14 of the carrier member 10 and to be perpendicular to the carrier member 10 and parallel to the base plate 20 (FIGS. 2-7). The carrier member 10 includes a lateral engaging groove 13 formed therein, such as formed to the lower or bottom portion 14 of the carrier member 10 and having a non-circular cross section, and includes an extension 15 laterally extended therefrom and includes a screw hole 16 formed in the extension 15 for threading or engaging with the screw 40, and the screw 40 is pivotally or rotatably engaged in the through hole 33 of the seat 30 and rotatably engaged through the compartment 21 of the base plate 20 and threaded and engaged with the screw hole 16 of the extension 15 of the carrier member 10 for allowing the carrier member 10 and the anchoring board 60 to be moved or slid up and down along and relative to the seat 30 and the base plate 20 by rotating or driving the screw 40 relative to the seat 30 with such as a driving tool 90 (FIG. 6). The engaging notch 22 of the base plate 20 is provided for slidably receiving or engaging with the extension 15 of the carrier member 10.

The anchoring board 60 includes one or more (such as two) pegs or protrusions or studs 61 extended therefrom, and the studs 61 each include an engaging hole 62 formed therein and to be aligned with the lateral engaging groove 13 of the carrier member 10. One or more (such as two) latch devices 7 are attached or mounted or secured onto the anchoring board 60, such as attached or mounted or secured to the studs 61 of the anchoring board 60 respectively for easily and quickly and readily and detachably attaching or mounting or securing or anchoring the anchoring board 60 to the lower or bottom portion 14 of the carrier member 10. The latch devices 7 each include a tubular member or casing 70 attached or mounted or secured to the respective stud 61 of the anchoring board 60 with soldering or welding processes, for example, and the casing 70 includes a channel or slot 71 formed therein.

The latch devices 7 each further include a latch member 73 slidably received or engaged in the casing 70 and also slidably received or engaged in the engaging hole 62 of the respective stud 61 of the anchoring board 60, and a hand grip or knob 74 is slidably received or engaged in the slot 71 of the casing 70 and attached or mounted or secured to the latch member 73 for moving the latch member 73 along the casing 70 and the engaging hole 62 of the stud 61 of the anchoring board 60, and for moving or extending the latch or actuating end 75 of the latch member 73 into or out of the engaging hole 62 of the stud 61 of the anchoring board 60, and for selectively engaging with the engaging groove 13 of the carrier member 10, and thus for selectively attaching or mounting or securing or coupling or anchoring the anchoring board 60 to the carrier member 10.

The latch or actuating end 75 of the latch member 73 also includes a non-circular cross section for selectively engaging with the corresponding non-circular engaging groove 13 of the carrier member 10 and for anchoring or securing or retaining the anchoring board 60 at a working position where the anchoring board 60 is substantially perpendicular to the carrier member 10 and parallel to the base plate 20, and thus for allowing the anchoring board 60 to be easily and quickly and readily attached or mounted or secured to the carrier member 10 with the latch devices 7, particularly after the lower or bottom portion 14 of the carrier member 10 is engaged through a tiny space beside the side or edge portion 81 of the table plate 8.

In operation, as shown in FIG. 5, the lower or bottom portion 14 of the carrier member 10 may be easily and quickly and readily engaged through a tiny space beside the side or edge portion 81 of the table plate 8, and the anchoring board 60 may then be easily and quickly and readily attached or mounted or secured to the carrier member 10 with the latch devices 7 at the working position where the anchoring board 60 is substantially perpendicular to the carrier member 10 and parallel to the base plate 20, for allowing the anchoring board 60 to be selectively engaged with the bottom surface 82 of the table plate 8, and for allowing the side or edge portion 81 of the table plate 8 to be received or engaged in or located between the base plate 20 and the anchoring board 60 (FIGS. 5-7). The carrier member 10 may then be caused to move relative to the base plate 20 and the seat 30 with the screw 40, and the anchoring board 60 may then be caused to move toward base plate 20 or toward the bottom surface 82 of the table plate 8 and to clamp and secure the side or edge portion 81 of the table plate 8 between the base plate 20 and the anchoring board 60 with the screw 40. It is to be noted that the anchoring board 60 may be easily and quickly and readily attached or mounted or secured to the carrier member 10 with the latch devices 7 at the working position where the anchoring board 60 is substantially perpendicular to the carrier member 10 and parallel to the base plate 20, after the lower or bottom portion 14 of the carrier member 10 has been engaged through a tiny space beside the side or edge portion 81 of the table plate 8, and for allowing the base plate 20 and the anchoring board 60 to be easily and quickly and readily attached or mounted or secured to the side or edge portion 81 of the table plate 8 by rotating or driving the screw 40 relative to the seat 30 with the driving tool 90 that is disposed or located above the seat 30 such that the user is not required to bend or squat lower than the supporting members or table 8.

Accordingly, the screw clamp in accordance with the present invention includes an improved structure arranged for allowing the screw clamp or carrier or support device to be easily actuated or operated by the user, and includes an anchoring board attachable to a carrier member for allowing the carrier member to be easily and quickly engaged through a tiny space beside an edge portion of a table plate and to be easily and quickly attached and mounted to the table plate.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A screw clamp comprising:
a carrier member,
an anchoring board detachably attached to said carrier member with at least one latch device, at a working position where said anchoring board is perpendicular to said carrier member,
a seat slidably attached to said carrier member and movable relative to said carrier member, and
a screw rotatably engaged with said seat and said carrier member for moving said carrier member and said anchoring board relative to said seat by rotating said screw relative to said seat and for allowing said anchoring board to be moved toward said seat with said screw.

2. The screw clamp as claimed in claim 1, wherein said carrier member includes two tracks, and said seat includes two engaging sockets formed therein for engaging with said tracks of said carrier member and for slidably anchoring said seat to said carrier member.

3. The screw clamp as claimed in claim 1, wherein said anchoring board includes at least one stud extended therefrom, and said at least one latch device is attached to said at least one stud.

4. The screw clamp as claimed in claim 3, wherein said at least one stud of said anchoring board includes an engaging hole formed therein, said at least one latch device includes a casing attached to said at least one stud, and a latch member slidably engaged in said casing and slidably engaged in said engaging hole of said at least one stud of said anchoring board and extendible out of said at least one stud to selectively engage with said carrier member.

5. The screw clamp as claimed in claim 4, wherein said casing includes a slot formed therein, and a knob is slidably engaged in said slot of said casing and secured to said latch member for moving said latch member along said casing and for moving said latch member to selectively engage with said carrier member.

6. The screw clamp as claimed in claim 4, wherein said carrier member includes an engaging groove formed therein for selectively engaging with said latch member.

7. The screw clamp as claimed in claim 6, wherein said engaging groove of said carrier member includes a non-circular cross section, and said latch member includes a non-circular actuating end for selectively engaging with said non-circular engaging groove of said carrier member and for anchoring said anchoring board to said carrier member at the working position where said anchoring board is perpendicular to said carrier member.

8. The screw clamp as claimed in claim 1, wherein said seat includes a through hole formed therein for engaging with said screw and includes a cavity formed therein and spaced from said through hole of said seat.

9. The screw clamp as claimed in claim 8, wherein said seat includes a cover having an aperture formed therein and aligned with said cavity of said seat.

10. The screw clamp as claimed in claim 9, wherein said seat includes at least one anchoring depression formed therein, and said cover includes at least one catch extended therefrom for engaging with said at least one anchoring depression of said seat and for anchoring said cover to said seat.

11. The screw clamp as claimed in claim 1, wherein a base plate is secured to said seat and slidably attached to said carrier member, and includes an orifice formed therein for engaging with said screw.
